(19) United States
(12) Patent Application Publication
(10) Pub. No.: US 2003/0211337 A1
(43) Pub. Date: Nov. 13, 2003

(54) Decorative films for windowpane

(76) Inventor: Motoaki Muraoka, Shizuoka (JP)

Correspondence Address: 3M INNOVATIVE PROPERTIES COMPANY, PO BOX 33427, ST. PAUL, MN, 55133-3427, US

(21) Appl. No.: 10/312,429

(22) PCT Filed: Jul. 3, 2001
(86) PCT No.: PCT/US01/21197

(30) Foreign Application Priority Data
Jul. 4, 2000 (JP) 2000-206853

(51) Int. Cl. B32B 17/10

(52) U.S. Cl. 428/432; 428/426

(57) ABSTRACT

To provide a decorative film for glass-paned window, which can simultaneously satisfies privacy protection effect, excellent visibility including light screening property, and excellent design and decorative effect. The decorative film applied to a glass-paned window through an adhesive layer is provided with at least one color developing resin layer containing a multilayered light interference material, which is capable of color developing as a function of light interference and has a high transparency, dispersed therein.

### FIELD OF THE INVENTION

The present invention relates to a decorative film for the pane of a window. The decorative film of the present invention can simultaneously provide excellent design, decorative effect, visibility and privacy protection effect when applied to transparent glass-paned or plastic-paned windows of structures such as houses and buildings, and transparent glass-paned or plastic-paned windows of vehicles such as cars and trains.

### BACKGROUND OF THE INVENTION

For the purpose of protecting privacy and screening light, it has widely been performed to coat a transparent glass-paned window with a special polarizing film through which the situation inside the room or vehicle can not be observed easily, heretofore. When the scene inside is observed from the outside through the glass-paned window to which the polarizing film is applied, the glass-paned window of a gray or similar halftone color can be seen, merely, but the situation inside can not be observed. Inside of the glass-paned window, the outside scene can be seen as usual and the view is not obstructed. The polarizing film is useful for protecting privacy and screening light because of its visibility. However, the color observed from the outside when using is black or gray, or a similar halftone color. Therefore, it has poor decorative effect and design.

Under the drawbacks of the polarizing film described above, a trial of improving the decorative effect without obstructing the visibility has also been made. For example, Japanese Unexamined Patent Publication (Kokai) No. 3-69397 discloses a decorative screen capable of performing different displays at both sides of a transparent door, a window and a partition in the room without obstructing see-through and light screening properties. As schematically shown in FIG. 1, this decorative screen has such a construction that a printing layer 24 having a lot of through-holes 25 is provided on a substrate 20 made of a transparent plastic or glass and the printing layer 24 has respectively a surface graphic layer 21 and a back surface graphic layer 23 via a screen ink layer 22 interposed between both graphic layers. This decorative screen can be produced by making a transfer sheet having the printing layer 24, forming a lot of through-holes 25, and transferring the transfer sheet on one surface of a substrate. For example, when this decorative sheet is applied to the glass-paned window, it is possible to see the opposite side through a lot of through-pores 25 formed on the printing layer 24 from any side, and to see a different pattern from each side. Therefore, it can be used for the purpose of advertising and decorating. However, in case of this decorative screen, it is necessary to make a transfer sheet as its precursor and, therefore, the production becomes complicated and an increase in cost is not avoided. Since the visibility of the decorative screen particularly depends on a lot of through-holes formed on the printing layer, it is impossible to obtain a good visibility which is comparable with that of the polarizing film. Furthermore, the printed pattern is unattractive because it depends on a normal printed technique, and a fine pattern can not be printed.

Japanese Unexamined Patent Publication (Kokai) No. 7-256849 discloses a functional decorative sheet 41 with a high-grade design comprising a transparent substrate sheet 42 and an uneven layer 43 formed on one surface of the transparent substrate sheet, as schematically shown in FIG. 2. On the surface opposite the uneven layer 43 of the substrate sheet 42, an adhesive layer 45 and a release paper 46 are laminated. The uneven layer 43 is made by dispersing a luster powder 44 in an ionizing radiation curing resin. This decorative sheet is characterized in that the particle diameter of the luster powder to be mixed with the ionizing radiation curing resin is within a range from 5 to 130 μm and that an uneven layer having a film thickness distribution of 5 to 100 μm is formed by mixing 3 to 15 parts of the luster powder with 100 parts by weight of the ionizing radiation curing resin. In the decorative sheet, the luster powder such as perlescent pigment coated with titanium dioxide is merely dispersed in the ionizing radiation curing resin so that there can not be obtained good visibility which is comparable with that of a polarizing film. The resultant design and decorative effect are still insufficient. In the decorative sheet, a special apparatus and step are required to form an uneven pattern, thereby to cause complicated production and increase in production cost. Furthermore, the uneven layer is exposed to the surface, thereby to cause drawbacks such as early lowering of design and short life due to stain and breakage during use.

Furthermore, Japanese Utility Model Registration No. 3041191 discloses a removable sheet-like advertising display capable of displaying advertising contents at the window portion of the side of transfer vehicles bodies such as car and train without obstructing the view. As shown in FIG. 3, since an advertising display 31 is applied to the portion including a portion of a window 35 of the side of a transfer vehicle body via an adhesive portion 34, the advertising display has through-holes 32 penetrating the sheet on the whole surface and, at the same time, an advertising display portion (a portion of the English letter is shown in the drawing) 33 is provided on the surface. The through-holes 32 are provided with enough size and distance so that the pattern of the advertising display portion 33 can be clearly confirmed from the outside of the vehicle body and, at the same time, the scene of the outside can be seen from the interior of the vehicle body to some extent. However, in case of this advertising display, since a main portion of the sheet is occupied by the through-holes, the amount of an adhesive to be applied to the adhesive portion of the back surface becomes small and a sufficiently strong adhesive force can not be obtained. Furthermore, there is also a problem that, while the advertising display is applied to the glass-paned window, dust accumulates on the portion of the through-holes and the portion of the adhesive squeezed out by a pressing force at the time of applying the sheet, thereby to lower the adhesive force and durability. Since the visibility of the advertising display depends on through-holes passing through the sheet, there can not be obtained a good visibility which is comparable with that of a polarizing film. The advertising display is produced by using the transfer method and perforating method in combination, similar to the decorative screen described previously with reference to FIG. 1. Accordingly, the production becomes complicated and there is a fear of causing such additional problems that an increase in cost is not avoided and a fine graphic pattern can not be printed.

### SUMMARY OF THE INVENTION

It is, therefore, an object of the present invention to solve the above problems of the prior art, thereby providing a decorative film for a window (e.g., glass-paned window), which can simultaneously satisfies privacy protection effect, excellent visibility including light screening property, and excellent design and decorative effect.

Another object of the present invention can be to provide a decorative film for a window, which has a simple structure and can be easily produced, and which is hardly stained or broken.

According to the present invention, the above objects can be accomplished by a decorative film applied to window via an adhesive layer, said decorative film comprising at least one color developing resin layer containing a multilayered light interference material, which is capable of developing color as a function of light interference and has a high transparency, dispersed therein.

The decorative film for a window comprises a color developing resin layer capable of developing a predetermined color when exposed to light and contains a multilayered light interference material, which is capable of developing color as a function of light interference and has a high transparency, dispersed therein, thereby making it possible to exert noticeable operation and effect, which have never been attained heretofore, in both aspects of the visibility and design. Even when using the same light interference material through control of the light transmittance and amount, the visibility and design can be changed to the desired level, respectively.

### BRIEF DESCRIPTION OF THE DRAWINGS

FIG. 1 is a cross-sectional view showing one example of a see-through decorative screen of the prior art.

FIG. 2 is a cross-sectional view showing one example of a functional decorative sheet with a high-grade design of the prior art.

FIG. 3 is a front view showing one example of an advertising display for transfer vehicle body.

FIG. 4 is a cross-sectional view showing one preferred embodiment of a decorative film for glass-paned window according to the present invention.

FIG. 5 is a cross-sectional view showing another preferred embodiment of a decorative film for glass-paned window according to the present invention.

FIG. 6 is a cross-sectional view showing a still another preferred embodiment of a decorative film for glass-paned window according to the present invention.

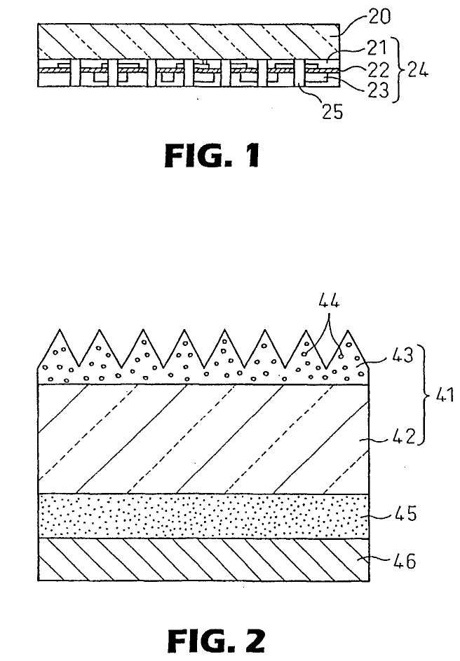

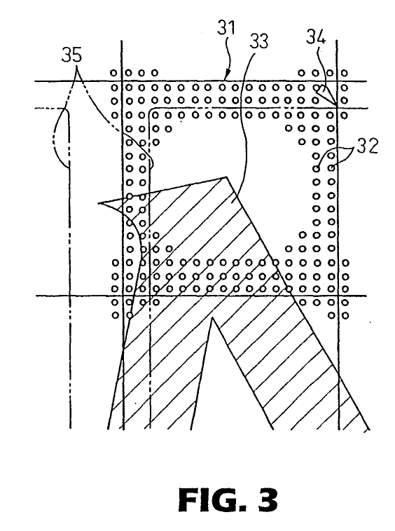

### DETAILED DESCRIPTION OF THE INVENTION

The decorative film for a window (e.g., glass-paned window) of the present invention preferably comprises one or more color developing resin layers, or comprises a transparent substrate and one or more color developing resin layers formed on one surface of the substrate. The decorative film may have a transparent adhesive layer to apply on the glass-paned window, or the transparent adhesive layer may be formed later. In case where the transparent adhesive layer is previously laminated, the surface may is preferably protected with a release liner such as release paper. Furthermore, a clear layer may be formed on the color developing resin layer to protect the color developing resin layer. Various embodiments will now be described in detail.

In the decorative film of the present invention, the color developing resin layer may be formed of any resin because its color developing function depends on the light interference material having a substantially multi-layer structure, as far as the light interference material can be uniformly dispersed and a resin layer having a predetermined thickness can be formed. Suitable resin include transparent resins designed particularly for printing, for example, urethane resin, acrylic resin, vinyl chloride resin, vinylidene fluoride resin, melamine-alkyd resin, polyester resin and chlorine-based polyolefin resin considering that the resin layer is preferably printed by using a conventional printing method such as screen printing method or gravure printing method. These ink resins may be used in combination, if necessary. Ultraviolet curing ink, electron beam curing ink, aqueous ink and the like can also be used. As far as a harmful influence is not exerted on the visibility, a semitransparent ink resin, e.g. a slightly colored ink resin may be used in place of the transparent ink resin.

The light interference material to be dispersed in the color developing resin layer is capable of developing a color by an interference action of light, and its color developing form is markedly different from that of a conventional one, depending on the laminated structure of the material to be used. The light interference material is not specifically limited as far as the color developing form is excellent. When using such a light interference material in the color developing resin layer, it has an operation and effect capable of changing the color and light due to an angle of one's gaze as a result of interference of light when reflected light and transmitted light are present. As nobody has anticipated heretofore, the color developing form of the light interference material is complicated and specific because plural layers of the light interference materials are laminated to complete one light interference material in comparison with the case when using a conventionally used luster powder. Accordingly, an excellent design and decorative effect can be exhibited, in addition to an excellent visibility.

Examples of the light interference material having such a multi-layer structure include, but are not limited to metals, for example, gold, silver, chromium and aluminum; metal oxides, for example, titanium oxide, tin oxide, aluminum oxide and iron oxide; metal fluorides, for example, magnesium fluoride; metal compounds, for example, cobalt titanate; silica, mica and glass. A multilayered light interference material which satisfies requirements of the present invention can be prepared by using these light interference materials in combination.

The multilayered light interference material can take a general form for the light interference material, for example, particles, powders and scales. The multi-layer structure in these materials is not specifically limited as far as it is composed of an integrated structure of layered materials, but is usually an integrated substance comprising a light interference material as a core material and a plurality of layered light interference materials which surround the light interference material, or a multi-layered integrated substance composed of two or more layered light interference materials. In such an integrated substance, the order of laminating these layered light interference materials is not specifically limited and the layered light interference materials can be used in combination depending on the desired color developing effect.

It is necessary that the light interference material has a high transparency so that the bright side can be observed from the dark side through the decorative sheet without causing disadvantages such as lowering of the visibility.

The light interference material is preferably used in the form of particles, as described above. The size (average particle diameter) of these particles can widely vary depending on the desired color developing effect, but is usually within a range from about 5 to 150 μm.

Describing in detail, the multilayered light interference material suited to work the present invention includes, but is not limited to, the following light interference materials:

five-layer structure light interference material composed of a combination of aluminum, magnesium fluoride and chromium, which is commercially available from Flex Inc., U.S.A., under the trade name of “Chroma Flair”;

five-layer structure light interference material composed of a combination of glass, silver and silica, which is commercially available from Nippon Sheet Glass Co., Ltd. under the trade name of “Metashine” series of RCFSX5090PS (2011), RCFSX5030PS (6034), RCFSX5080TS (6044) and RCFSX5090RC;

five-layer structure light interference material composed of a combination of mica, tin oxide and titanium oxide or a combination of mica, titanium oxide and cobalt titanate, which is commercially available from Merk Co., U.S.A., under the trade name of “Iriodin”, “Ultra 7200” or “Iriodin New GP” series; and

other light interference materials, which are commercially available from Engelhard Co., U.S.A, under the trade name of “MERALIN” series or commercially available from Nihon Koken Kogyo Co., Ltd. under the trade name of “PEARL-GRAZE” and “ULTIMICA”.

The content of the light interference material in the color developing resin layer can widely vary depending on the desired color developing effect, but is advantageously within a range from about 5 to 65 wt %. When the content of the light interference material is less than 5 wt %, the desired color developing effect derived from its material can not be obtained. On the other hand, when the content is more than 65 wt %, not only a remarkable improvement in color developing effect can not be expected, but also a harmful influence is exerted on the visibility of the film. The content of the light interference material is more preferably within a range from about 15 to 45 wt %.

The light interference material can be mixed with the color developing resin by a conventional procedure. That is, the color developing material and light interference material can be sufficiently mixed by using a kneader and other mixing apparatuses after weighing them in a predetermined amount. If necessary, arbitrary additives may be additionally contained in the color developing resin layer. Suitable additives include, for example, pigments, dispersion accelerators, leveling agents and defoamers.

The color developing resin layer can be formed by printing a suitable ink resin prepared by mixing the above-described light interference materials, using a conventional printing method such as screen printing method or gravure printing method. The printing may be single-color printing or multi-color printing. Furthermore, the printing may be solid printing. Alternatively, pattern printing may also be conducted, if necessary. The color developing resin layer may be formed by single-layer printing or two- or more-layer printing.

The film thickness of the color developing resin layer can widely vary depending on the portion to which the decorative film is applied, or desired decorative effect, but is preferably within a range from about 3 to 80 μm. When the film thickness of the color developing resin layer is less than 3 μm, sufficient desired color developing effect derived from the light interference material can not be obtained. On the other hand, when the film thickness is more than 80 μm, a harmful influence is exerted on the visibility of the decorative film.

It is necessary that the color developing resin layer has the transparency of the predetermined level to bring out the effect of the present invention. The transparency of the color developing resin layer is preferably within a range from about 35 to 80% in terms of the light transmittance. When the light transmittance of the color developing resin layer is less than 35%, problems such as lowering of the visibility can occur. On the other hand, when the light transmittance is more than 80%, problems such as lowering of the privacy imparting function, design and color development can occur.

The decorative film of the present invention is preferably provided with a transparent adhesive layer. The transparency of the adhesive layer may be the almost the same as that of the above color developing resin layer. For example, the decorative film is composed of a transparent substrate, and a color developing layer and a clear layer formed thereon in order, and a transparent adhesive layer is laminated on the side opposite the color developing layer of the transparent substrate. The decorative film may be previously provided with an adhesive layer, or the adhesive layer may be designed to apply to the decorative film at any stage before applying to the glass-paned window. For example, the adhesive layer can be formed by coating a transparent adhesive such as rubber adhesive, acrylic adhesive, vinyl adhesive or silicone adhesive in a predetermined film thickness.

The transparent adhesive layer preferred in the practice of the present invention is an adhesive layer with a release liner. This kind of the adhesive layer can be commercially available, easily. Use of such an adhesive layer with a release liner in combination with the decorative film for glass-paned window of the present invention enables users to easily perform industrial or large-scale application of the decorative film industrially, or to apply the decorative film to glass-paned windows of one's own house and car without asking professional workers.

The clear layer to be formed on the color developing resin layer preferably has the weathering resistance and heat resistance, in addition to the transparency as an inherent essential property, in order to enable the clear layer to serve as a protective film, and can be preferably formed by selecting a suitable resin from various resins capable of satisfying the property. The clear layer preferably has a good close adhesion with the color developing resin layer as a ground. Examples of the resin suited to form the clear layer include, but are not limited to, polyester resin, polyethylene resin, polycarbonate resin, polyurethane resin, vinyl chloride resin, acrylic resin and vinylidene chloride resin. The film thickness of the clear layer can vary depending on the desired effect, but is preferably within a range from about 5 to 100 μm, and more preferably from about 20 to 75 μm. Furthermore, it is expected to afford luster to the surface of the decorative film as the additional operation and effect of the clear layer.

The decorative film of the present invention may not be supported with the substrate if the color developing resin layer is self-supporting, but is preferably supported with the substrate or other materials.

When using the substrate in working of the present invention, a transparent substrate is preferably used. The transparent substrate is not specifically limited as far as it has enough self-supporting property to support the color developing resin layer, but is preferably a plastic film. Examples of suitable plastic film include, but are not limited to, polyester film, polyethylene film, polycarbonate film, polyurethane film, vinyl chloride film, acrylic film and vinylidene fluoride film. The film thickness can vary depending on uses of the decorative film of the present invention, but is usually within a range from about 20 μm to 5.0 μm. Such a substrate is preferably transparent, but may be semitransparent or slightly colored as far as a harmful influence is not exerted on the desired effect of the present invention.

The decorative film of the present invention can optionally comprises a substrate, a transparent layer and a clear layer, in addition to a color developing resin layer which is essential in its structure. The decorative film of the present invention can further comprise other layers. Suitable additional layer includes, for example, surface protective film layer.

The windowpane to which the decorative films of the present invention includes a variety of windowpanes. For example, it may be windowpanes of structures such as houses and buildings, or windows of mobiles such as cars and trains. Further, the windowpanes may be a single-layered pane or a multilayered pane. Furthermore, they may be formed from glass, plastic material or a combination thereof.

### EXAMPLES

The following examples further illustrate the present invention.

### Example of the Decorative Film

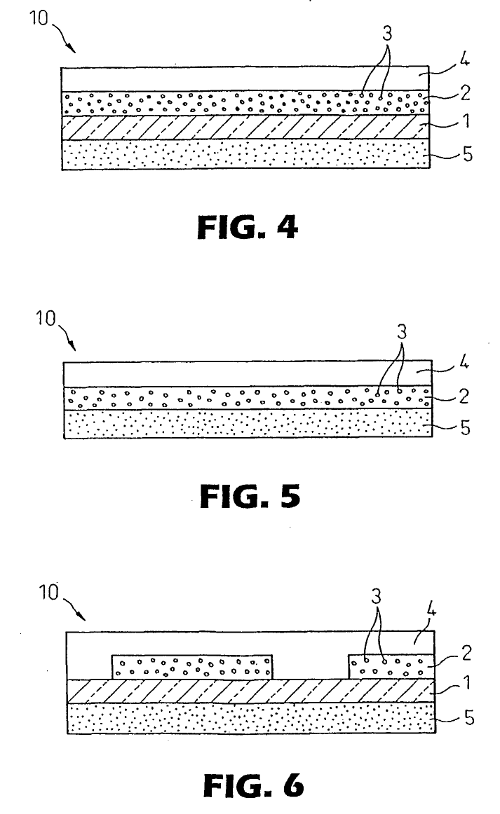

FIG. 4 is a cross-sectional view showing one preferred example of a decorative film for glass-paned window of the present invention. A decorative film 10 comprises a color developing resin layer 2 containing a multi-layer structure light interference material 3 dispersed therein, which is provided on one surface of a transparent film-like substrate 1. On the color developing resin layer 2, a clear layer 4 is provided for the purpose of protecting the resin layer 2 and affording luster. On the surface opposite the color developing resin layer 2 of the film-like substrate 1, an adhesive layer 5 with a release liner (not shown) is provided. This decorative film is particularly designed for glass-paned window of cars. In case of applying on the glass-paned window, the decorative sheet can be applied to the outside of the glass-paned window via the adhesive layer after removing the release liner. The production and effect of the decorative film shown in the drawing will be described with reference to the following Examples 1 to 7.

FIG. 5 is a cross-sectional view showing another preferred example of a decorative film for glass-paned window of the present invention. In a decorative film 10 shown in the drawing, a transparent film itself, which is obtained by mixing 10% of an interference color developing type multi-layer structure pigment with the substrate (resin), serves as a color developing layer. This decorative film also simultaneously gives rise to an excellent visibility and design.

FIG. 6 is a cross-sectional view showing a still another preferred example of a decorative film for glass-paned window of the present invention. A decorative film 10 shown in the drawing has the same structure as that of the decorative film 10 described previously with reference to FIG. 4 except that the color developing resin layer 2 was printed in a pattern on the transparent film-like substrate. This decorative film also simultaneously gave rise to an excellent visibility and design, thereby making it possible to enhance the decorative effect derived from the patterned interference color development.

### Example 1

Preparation of Decorative Film Shown in FIG. 4

As the substrate, a transparent vinyl chloride film with an adhesive for glass (manufactured by Sumitomo 3M Co., Ltd. under the trade name of “S/C 3669”) was prepared. The size of the vinyl chloride film was 18 cm in width×120 cm in length×80 μm in thickness. After an interference color developing multi-layer structure pigment (manufactured by Flex Inc. under the trade name of “Chroma Flair”) was mixed with a transparent ink resin for silk screen printing (manufactured by 3M Co., Ltd. under the trade name of “Scotchcal™ S/C 3910”) at a mixing ratio of 65:35 in the solid content of the resulting film, silk screen printing of a flower pattern was performed on one surface (non-adhesive surface) of the vinyl chloride film by using the resulting ink. The transparent ink resin “Scotchcal™ S/C 3910” used herein comprises 30 to 60% of cyclohexanone, 15 to 40% of vinyl chloride-vinyl acetate polymer, and 15 to 40% of isophorone. The film thickness of the color developing resin layer with a flower pattern was about 5 μm. It was possible to print as the present inventors wished to a fine portion of the flower pattern. The visible light transmittance of the color developing resin layer was about 39.4%.

After the completion of the silk screen printing, a acylic resin-based clear coating composition (overprint clear paint, manufactured by 3M Co., Ltd. under the trade name of “Scotchcal™ S/C 3920” was coated in the thickness of 25 μm and then dried for the purpose of protecting the surface and imparting the light resistance and luster to the surface. The clear paint “Scotchcal™ S/C 3920” contains 65 to 75% of heavy aromatic solvent naphtha. and 20 to 30% of polyethyl methacrylate as principal components. On the back surface (adhesive surface) of the vinyl chloride film, an application tape (manufactured by Sumitomo 3M Co., Ltd. under the trade name of “FPM-105WG”) was laminated. The application tape comprises a propylene film of a thickness of 100 μm having applied to a single surface thereof a rubber-based adhesive layer of a thickness of 10 μm.

The decorative film made as described above was applied on the outside of a rear glass of a car by using a squeegee. The decorative film was observed from the outside of the car under sunlight. As a result, the flower pattern printed in the previous step could be clearly observed with excellent interference color-developed luster. The inside of the car could not be observed through the decorative film. This is caused by the state where the dark side can not be confirmed by light reflection of the light interference pigment having a multi-layer structure. That is, when the decorative film is observed from the outside of the car, the same state as that in case of coating the black surface with the light interference pigment is formed because of dark inside of the car. Then, the outside of the car was observed from the outside of the car through the decorative film under the same sunlight. As a result, the flower pattern observed previously could not be recognized and the outside scene could be observed without any obstruction. The observer's view was not obstructed by the presence of the decorative film. In this case, since the car glass observed from the inside of the car appears to be bright, the same state as that in case of coating the white surface with the light interference pigment, thus causing no color development.

The results of this example and other examples are summarized in Table 1 below. The column of “function and appearance” describes general evaluation of the results obtained by applying the decorative film on the outside of the rear glass of the car and observing the inside and outside of the car. In the case of this example, since satisfactory results were obtained as described above, samples were rated “Good”.

The above procedure was repeated except that an application tape was laminated on the clear layer. The resulting film was applied on the inside of the rear glass of the car and the flower pattern was observed in the same manner as that described above. The same results were obtained.

Furthermore, the decorative film made as described above was applied on the whole surface of the show window, not on the rear glass of the car, and the effect was observed. As a result, an excellent visibility and design could been recognized simultaneously.

### Examples 2 to 6

The same procedure as that described in Example 1 was repeated, except that the mixing ratio of the interference color developing type multi-layer structure pigment was changed as described in Table 1 below and that the film thickness of the color developing resin layer was also changed in this example. The results as described in Table 1 below were obtained.

### Example 7

The same procedure as that described in Example 1 was repeated, except that the interference color developing type multi-layer structure pigment was changed to “Matashine” (trade name) manufactured by Nippon Sheet Glass Co., Ltd. and that its mixing ratio was changed to 25% in this example. The results as described in Table 1 below were obtained.

### Comparative Examples 1 to 4

The same procedure as that described in Example 1 was repeated, except that the mixing ratio of the interference color developing type multi-layer structure pigment was changed as described in Table 1 below for comparison in these comparative examples and that the film thickness of the color developing resin layer was also changed in Comparative Examples 2 and 3. The results as described in Table 1 below were obtained.

### Comparative Example 5

The same procedure as that described in Example 1 was repeated, except that the interference color developing type multi-layer structure pigment was changed to “Matashine” (trade name) manufactured by Nippon Sheet Glass Co., Ltd. and that its mixing ratio was changed to 4% in this comparative Example. The results as described in Table 1 below were obtained.

TABLE 1

| | Film | Mixing ratio of | Visible light | |
|---|---|---|---|---|
| | thickness | interference color | transmittance | |
| | of color | developing type | of color | |
| | developing | multi-layered | developing | |
| | resin layer | structure pigment | resin layer | Function and |
| Examples | (μm) | (%) | (%) | appearance |
| Example 1 | 5 | 65 | 39.4 | Good |
| Example 2 | 5 | 30 | 63.9 | Good |
| Example 3 | 10 | 20 | 62.2 | Good |
| Example 4 | 30 | 10 | 51.2 | Good |
| Example 5 | 75 | 5 | 36.8 | Good |
| Example 6 | 5 | 30 | 59.9 | Good |
| Example 7 | 5 | 25 | 80.1 | Good |
| Comp. | 5 | 75 | 30.4 | Lowering of |
| Example 1 | | | | visibility |
| Comp. | 2 | 30 | 86.5 | Lowering of |
| Example 2 | | | | privacy |
| Comp. | 90 | 3 | 24.4 | Lowering of |
| Example 3 | | | | visibility |
| Comp. | 5 | 75 | 28.7 | Lowering of |
| Example 4 | | | | visibility |
| Comp. | 5 | 4 | 91.5 | Lowering of |
| Example 5 | | | | privacy |

As is apparent from the results described in Table 1, good function and appearance could been obtained in the decorative films of the present invention. In the decorative films of the comparative examples, disadvantages such as lowering of the visibility and privacy occurred.

As described above, when the decorative film according to the present invention is applied to the place where there is a difference in brightness between the inside and outside, for example, transparent glass-paned windows of structures such as houses and buildings, and transparent glass-paned windows of vehicles such as cars and trains, the inside situation can not be seen through when observing the comparatively dark inside of the room or vehicle from the comparatively light outside of the room or vehicle. Therefore, excellent privacy protection effect and light screening can be attained.

When using the decorative film of the present invention actually, there can be attained the satisfactory visibility corresponding to that of a polarizing film that has conventionally been used.

Since a multilayered light interference material having a high transparency was dispersed in a color developing resin layer constituting a decorative surface in the decorative film of the present invention, there can be provided noticeable design and decorative effect which could have never been exhibited by a luster powder that has conventionally been used.

When the decorative sheet of the present invention is actually applied to the glass-paned window, a colored pattern having an excellent design and decorative effect, for example, letters, graphics and designs can be visually recognized on the dark background of the glass-paned window in a conspicuous state. On the other hand, when the outside of the window was observed from the inside or the room or the outside of the car, not only the colored pattern of the glass-paned window can not be visually recognized, but also the outside scene can be observed without any obstruction. Accordingly, the decorative film of the present invention is useful for protecting privacy and screening light. In addition, it makes possible to use the glass-paned window, which has never been used positively, heretofore, for the purpose of performing advertising display and display. Not only the decorative film of the present invention is capable of printing a fine graphic by a simple technique, but also it is superior in adhesive force to the glass-paned window.

We claim:

1. A decorative film applied to a windowpane through an adhesive layer, said decorative film comprising at least one color developing resin layer containing a multilayered light interference material, which is capable of developing color as a function of light interference and has a high transparency, dispersed therein.

2. The decorative film for windowpane according to claim 1, wherein the multi-layer structure of the light interference material comprises at least one layer made of one member selected from the group consisting of metal or an oxide or fluoride thereof, silica, mica and glass.

3. The decorative film for windowpane according to claim 1 or 2, wherein the light interference material is contained in the amount of 5 to 65 wt % based on the resin used in the color developing resin layer.

4. The decorative film for windowpane according to any one of claims 1 to 3, wherein a light transmittance of the color developing resin layer is within a range of from 35 to 80%.

5. The decorative film for windowpane according to any one of claims 1 to 4, wherein a film thickness of the color developing resin layer is within a range of from 3 to 80 μm.
